(19) United States
(12) Patent Application Publication
(10) Pub. No.: US 2002/0180129 A1
(43) Pub. Date: Dec. 5, 2002

(54) Hydraulically damped mounting device

(76) Inventors: Paul Frobisher, Chippenham (GB); Peter Michael Trewhella Fursdon, Bradford-on-Avon (GB)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 10/154,148

(22) Filed: May 23, 2002

(30) Foreign Application Priority Data
Jun. 1, 2001 (GB) 0113372.7

(51) Int. Cl. F16F 5/00

(52) U.S. Cl. 267/140.11

(57) ABSTRACT

A hydraulically damped mounting device has a first anchor part in the form of a cup and a second anchor part in the form of a boss connected to the cup by a deformable wall. The deformable wall bounds a working chamber for hydraulic fluid which is connected to a compensation chamber by a passageway. A sleeve is provided extending around the mounting device, with one end secured to the cup and the other end secured to the boss. The cup may have a resilient mounting plate to which the sleeve is attached. Alternatively, the cup and boss may have resilient clips resting thereon, and straps connecting the cup and boss via the clips, such that the straps clips form a complete loop around the mounting device.

### BACKGROUND OF THE INVENTION

1. Field of the Invention

The present invention relates to a hydraulically damped mounting device. Such a device usually has a pair of chambers for hydraulic fluid, connected by suitable passageway, and damping is achieved due to the flow of fluid through that passageway.

2. Summary of the Prior Art

EP-A-0115417 (corresponding to U.S. Pat. No.4,657,232,the disclosure of which is incorporated herein by reference) and GB-A-b 2282430 (the disclosure of what is incorporated herein by reference) discussed a type of hydraulically damped mounting devices for damping vibration between two parts of a piece of machinery, e.g. a car engine and a chassis, referred to as a “cup and boss” type of mounting device, in which a “boss”, forming one anchor part to which one of the pieces of machinery was connected, was itself connected via a deformable (normally resilient) wall to the mouth of a “cup”, which was attached to the other piece of machinery and formed another anchor part. The cup and the resilient wall then defined a working chamber for hydraulic fluid, which was connected to a compensation chamber by a passageway (usually elongate) which provided the damping orifice. The compensation chamber was separated from the working chamber by a rigid partition, and a flexible diaphragm was in direct contact with the liquid and, together with the partition formed a gas pocket.

In the hydraulically damped mounting devices disclosed in the specifications discussed above, there was a single passageway. It is also known, from other hydraulically damped mounting devices, to provide a plurality of independent passageways linking the chambers for hydraulic fluid.

FIG. 1 of the accompanying drawings shows one example of a “cup and boss” type of mounting device, and has been disclosed in our GB-A-2282430. The mounting device is for damping vibration between two parts of a structure(not shown), and has a boss 1 connected via a fixing bolt 2 to one of the parts of the structure, and the other part of the structure is connected to a generally U-shaped cup 4. A resilient spring 5 of e.g. rubber interconnects the boss 1 and the cup 4. A partition 7 is also attached to the cup 4 adjacent the ring, and extends across the mouth of the cup 4. Thus, a working chamber 8 is defined within the mount, bounded by the resilient spring 5 and the partition 7.

The interior of the partition 7 defines a convoluted passageway 9 which is connected to the working chamber 8 via an opening 10 and is also connected via an opening 11 to a compensation chamber 12. Thus, when the boss 1 vibrates relative to the cup 4 (in the vertical direction in FIG. 1), the volume of the working chamber 8 will change, and hydraulic fluid in that working chamber 8 will be forced through the passageway 9 into, or out of, the compensation chamber 12. This fluid movement causes damping. The volume of the compensation chamber 12 needs to change in response to such fluid movement, and therefore the compensation chamber 12 is bounded by a flexible wall 13.

In use, the force received by the mounting device is principally parallel to the fixing bolt 2, and this direction defines an axis of the boss 1.

The above structure is generally similar to that described in EP-A-0115417, and the manner of operation is similar. In EP-A-0115417, the partition supported a diaphragm which acted as a boundary between fluid in the working chamber and a gas pocket. In the arrangement shown as FIG. 1, there is an annular diaphragm 50 which is convoluted. That diaphragm 50 is held on the partition 7 by an upper snubber plate 22, that snubber plate 22 is held in pace by a ring 40, which is clamped to the partition 7 and to the cup 4, by a clamping ring 41. The resilient spring 5 is also connected to the ring 40. The upper snubber plate 22 has openings which permits fluid in the working chamber 8 to contact the diaphragm 50.

In the arrangement shown in FIG. 1, the passageway 9 is in the form of a spiral, and the internal dimensions of that spiral are uniform. Under normal operation, the resilient wall is sufficiently strong to resist the forces that will be applied to it due to movement of e.g. the engine relative to the chassis. However, if the vehicle is involved in a crash or in some extreme driving conditions, very large forces can be applied to the mount due to movement of the engine relative to the chassis, and it is desirable to provide additional restraint on the movement of the boss relative to the cup to prevent excessive movement of the engine. It is therefore known to provide a strap, usually of braided steel or wire, which extends around the mounting device so as to pass over the boss and under the cup to provide a restraint on the total movement of the mounting device.

### SUMMARY OF THE INVENTION

The present invention, in its various aspects, is concerned with arrangements providing additional restraint on the movement of the boss relative to the cup, which do not use a continuous strap which extends around the mounting device.

In the first aspect of the invention, a sleeve of flexible but generally inelastic material extends around the mounting device, with one end of the sleeve secured to the cup and the other end secured to the boss. The ends of the sleeve may, for example, have beads which engage corresponding projections on the mounting device. The structure of the sleeve is thus somewhat similar to a vehicle tyre, and may be formed by similar techniques.

One end of the sleeve may be secured to the boss by a mounting plate which itself may be resiliently deformable. The sleeve may be secured to that mounting plate by securing an outer ring around the plate, which traps the sleeve between that ring and the plate, with sliding being resisted by a bead at the end of the sleeve. The mounting plate may equally be positioned on the cup where it can perform the same function.

The possibility of using a resilient mounting plate is then developed in a second aspect of the invention, in which two flexible but generally inelastic straps are connected by resilient clips, which resilient clips rest on the cup and the boss respectively, and engage each strap so that the straps and the clips together form a loop around the mount.

Such a construction has the advantage that it is relatively straight forward to use the resilience of the clip to fix the straps on to the mount, unlike the known arrangements using steel wires.

In the above discussion, the sleeve and straps were described as generally inelastic. By this is meant the stiffness, in terms of the force required for unit extension is at least 1×10⁶ Nm⁻¹. More preferably this is at least 2×10⁶ Nm⁻¹. On the other hand stiffness greater than 10×10⁶ Nm⁻¹ may be difficult to achieve with otherwise suitable materials.

For example, the sleeve and straps may be of Kevlar or similar aramid fibre. It may also be possible to achieve satisfactory stiffness with a mesh of fibres embedded in a sheet of e.g. rubber material.

It is also possible to provide at least one resilient pad between the sleeve/strap and the mount. E

### BRIEF DESCRIPTION OF THE DRAWINGS

Embodiments of the present invention will now be described in detail, by way of example, with reference to the accompanying drawings in which;

FIG. 1 is a hydraulically damped mounting device as in GB-A-2282430 and has already been described.

FIG. 2 is a schematic sectional view through a hydraulically damped mounting device being a first embodiment of the present invention;

FIG. 3 is a perspective view of a hydraulically damped mounting device according to a second embodiment of the present invention;

FIG. 4 is side view of the mounting device of FIG. 3;

FIG. 5 is a top view of the mounting device of FIG. 3;

FIG. 6 is a bottom view of the mounting device of FIG. 3;

FIG. 7 is a side view of a modification of the mounting device of FIG. 2; and

FIG. 8 is a modification of the mounting device of FIG. 4.

### DETAILED DESCRIPTION

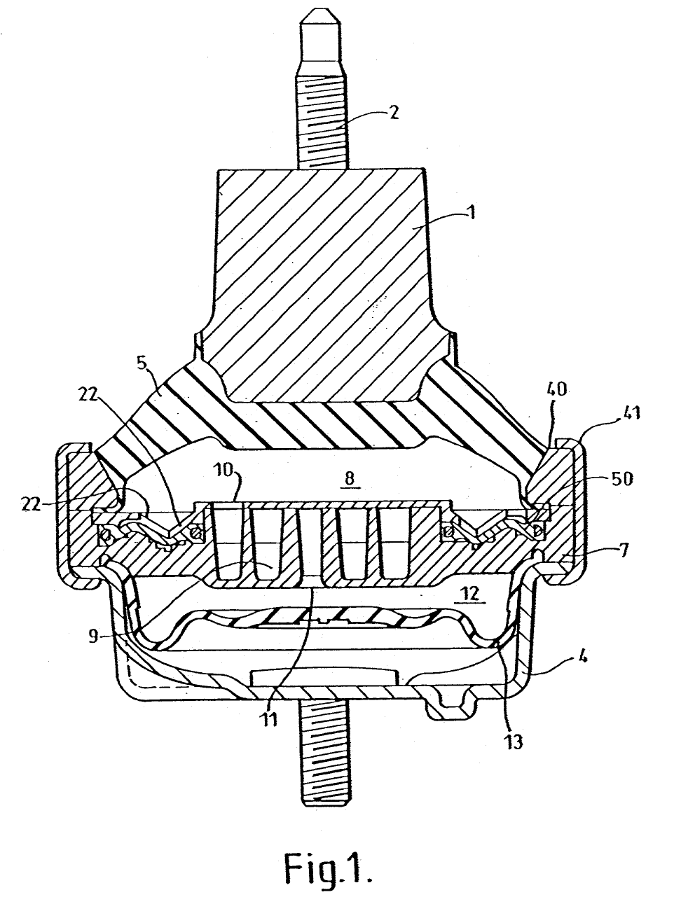

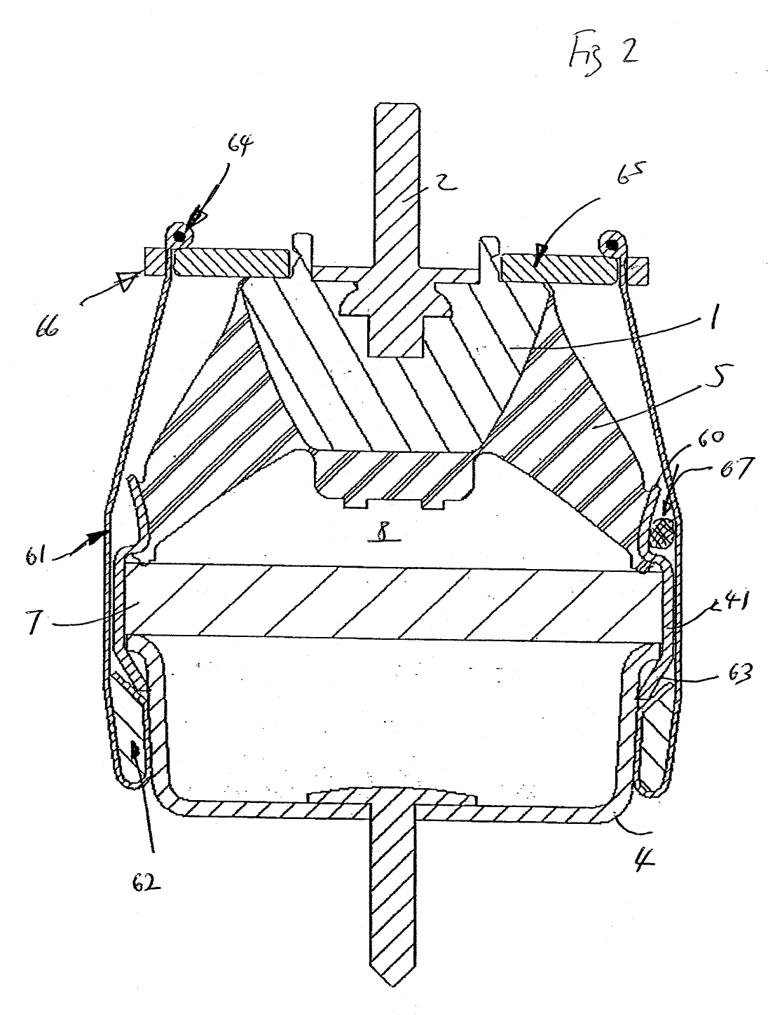

The first embodiment of the invention will now be described with reference to FIG. 2. The parts which correspond to parts of the arrangement of FIG. 1 are indicated by the same reference numerals. Moreover, it should be noted that the internal structure of the mounting device shown in FIG. 2 is simplified, omitting the passageway 9 and the compensation chamber 12 in FIG. 1. They will be present in any practical embodiment. Moreover, in the embodiment of FIG. 2, the resilient wall 5 is connected to a flange 60 on the clamping ring 41, rather than via the ring 40 clamped to the partition 7 in FIG. 1.

In this embodiment, a flexible inelastic sleeve 61 extends around the mounting device. The sleeve 61 is generally cylindrical, with open ends. A bead 62 is secured to one end of the sleeve, to abut against a bottom flange 63 of the clamping ring 41, so that the bead 62 cannot move upwardly in FIG. 2. The other end of the sleeve 61 also has a bead 64 which over-lies a mounting plate 65, resting on the boss 1. An outer ring 66 secures the sleeve to the mounting ring 65.

Thus, excessive upward movement of the boss 1 relative to the cup 4 prevented by the sleeve 61. The mounting plate 65 may be rigid, but preferably has some resilience. Thus, a degree of upward movement of the boss 1 relative to the cup 4 from the position shown in FIG. 1 is possible, due to the resilience of the mounting plate 65, but the force created by that resilience resists such a movement.

In this embodiment, a rubber or other resilient body 67 may be provided adjacently upper flange 60 of the clamping ring 41, to prevent damage to the sleeve 61 by that flange 60. The body 67 also provides resilience to the structure when a force is applied to the mount.

To form such a mount, the sleeve 61 is positioned over the mounting device, and the mounting plate 65 manipulated until the bead 64 is above it. Then, the outer ring 66 is positioned to lock the bead 64 in place.

As previously mentioned, the sleeve 61 is preferably a mesh of Kevlar or nylon material coated with rubber. This enables appropriate stiffness of the sleeve to be achieved. The sleeve may then have a coating of heat reflective material, such as aluminium. It may also be possible to achieve sufficient stiffness using a Kevlar or nylon mesh and the aluminium coating, without the rubber material.

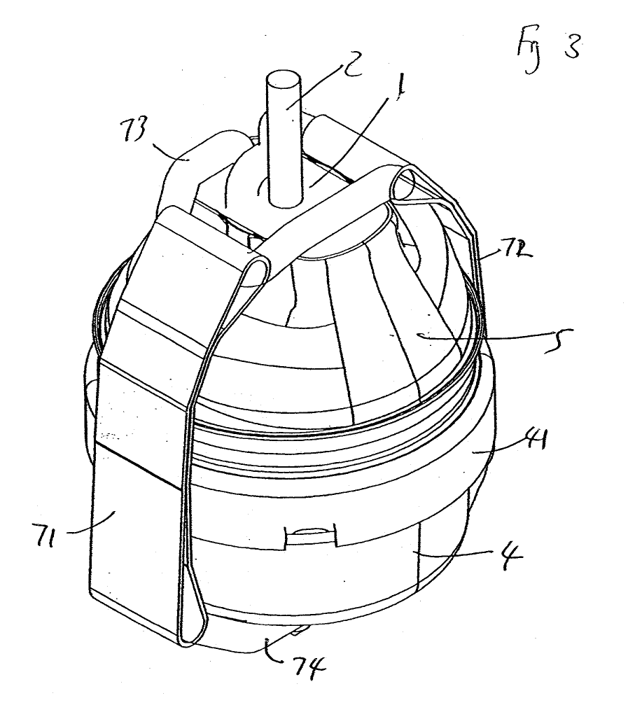

In the embodiment of FIG. 2, the sleeve 61 extends wholly around the mounting device. FIG. 3 illustrates a second embodiment, in which inelastic straps 71, 72 are provided which extend partially around the mount, and are interconnected by upper and lower clips 73, 74 respectively. Other parts of the mounting device correspond to the structure of FIG. 1, and are indicated by the same reference numerals.

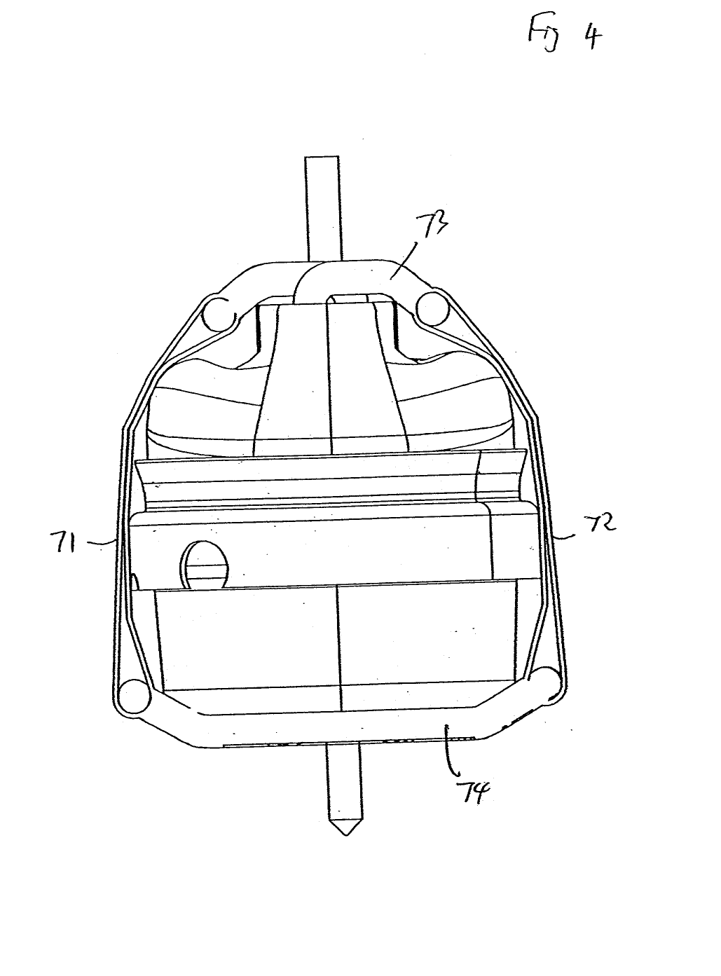

The side view of the second embodiment, in FIG. 4, shows that the straps 71, 72 are each in the form of a loop, through which parts of the clips 73, 74 are received at the ends of the straps 71, 72 to secure the strap 71, 72 to those clips 73, 74.

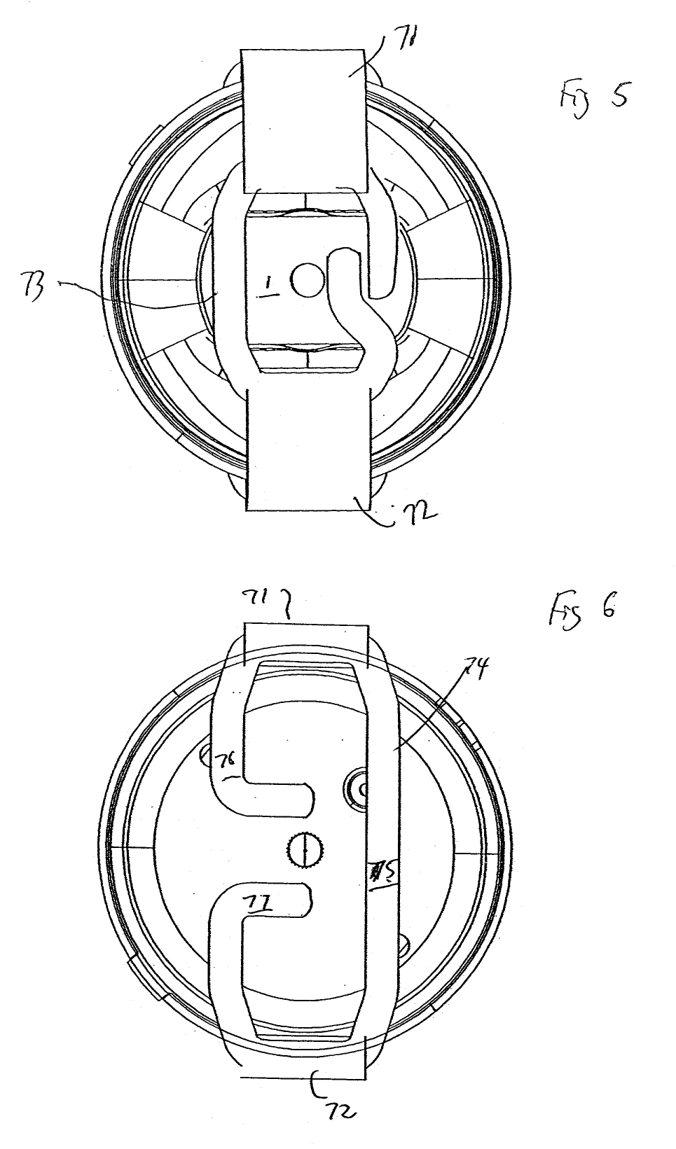

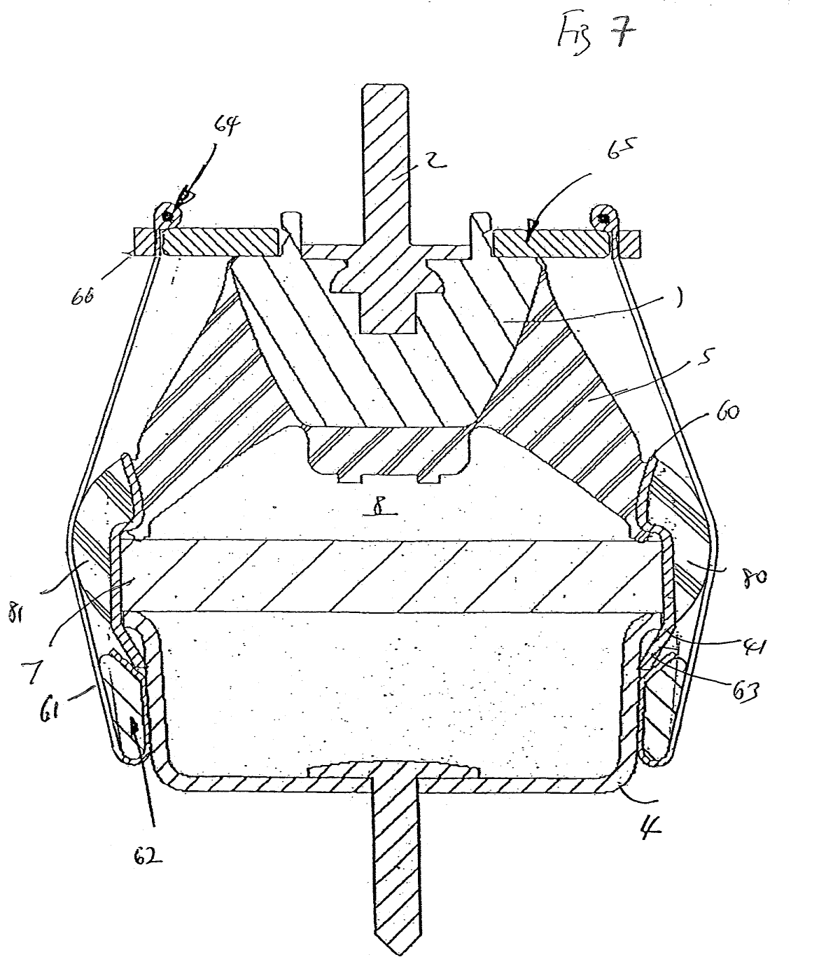

FIG. 5 shows that the upper clip 73, which over-lies the boss 1, is in the general form of the letter G, so that the end of the strap 71, 72 can be passed through the mouth of the G to fit in place. FIG. 6 shows that the lower clip 74, which contacts the base of the cup 4, has a continuous part 75 extending between the straps 71, 72, and two parts 76, 77 which form a mouth therebetween to permit the straps to be positioned on the clip 74.

The clips 73, 74 are not rigid, and their resilience is chosen to provide sufficient deformability of the mounting device, but not excessive deformability that could result in damage to the mounting device. In the embodiments described above, the sleeve 60 and the straps 71, 72 may be made of e.g. Kevlar or similar material which provides sufficient inelasticity.

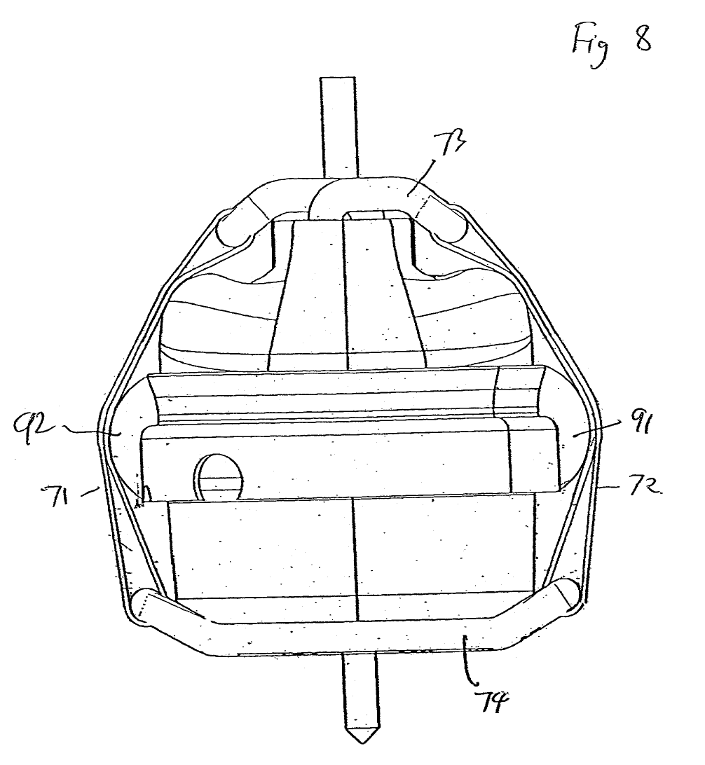

In FIG. 2, a rubber or other resilient body 67 was provided between the sleeve 61 and the bracket 41. This may be developed further, as shown in FIG. 7, by the provision of larger resilient pads 80, 81 on the sleeve 41. The arrangement of FIG. 7 is otherwise the same as that of FIG. 2, and corresponding parts are indicated by the same reference numerals. The rubber pads 80, 81 provide more of a resilient effect, which may be useful in some circumstances. When the boss 1 moves upwardly, elative to the cup 4, the sleeve 61 compresses the pads 80, 81, thus allowing some movement. However, the forces thus generated by compression of the pads 80, 81 eventually resist further inward movement of that part of the sleeve 61, and the relative inelasticity of the sleeve 61 then prevents further movement.

A similar arrangement is illustrated in FIG. 8, for the embodiment of FIG. 4. Again, pads 91, 92 are provided between the straps 71, 72 and the rest of the mount. The mount in FIG. 8 is otherwise the same as that of the embodiments of FIGS. 3 to 6 and corresponding parts indicated by the same reference numerals. The pads 91, 92 provide a similar effect in this embodiment to the pads 81, 82 in the embodiment of FIG. 8.

1. A hydraulically damped mounting device comprising:
first and second anchor parts connected by a first deformable wall;
a working chamber at least partially bounded by the first deformable wall;
a compensation chamber for hydraulic fluid, the compensation chamber being bounded by a second deformable wall;
a passageway for the hydraulic fluid, interconnecting the working and compensation chambers; and
a generally inelastic flexible sleeve extending circumferentially around the working chamber and between the first and second anchor parts, such that the sleeve and the first and second anchor parts form a loop around the working chamber.

2. A hydraulically damped mounting device according to claim 1, wherein one of the anchor parts includes a mounting plate, one end of the sleeve making abutting contact with the mounting plate.

3. A hydraulically damped mounting device according to claim 2, wherein the mounting plate is made of resilient material.

4. A hydraulically damped mounting device according to claim 1, wherein at least one end of the sleeve has beads which abut projections on the mounting device.

5. A hydraulically damped mounting device according to claim 1, having at least one resilient pad between the sleeve and another part of the mounting device.

6. A hydraulically damped mounting device according to claim 1, wherein the stiffness of the straps/sleeve is at least 1×10⁶ Nm⁻¹.

7. A hydraulically damped mounting device according to claim 1, wherein the first anchor part is a cup containing the compensation chamber, the cup having an open mouth, and the second anchor part is a boss aligned with the mouth of the cup and connected thereto by the first deformable wall.

8. A hydraulically damped mounting device according to claim 1, having a partition dividing the working chamber from the compensation chamber, wherein the passageway connecting the working chamber and the compensation chamber is in the partition.

9. A hydraulically damped mounting device comprising:
first and second anchor parts connected by a first deformable wall;
a working chamber at least partially bounded by the first deformable wall;
a compensation chamber for hydraulic fluid, the compensation chamber being bounded by a second deformable wall;
a passageway for the hydraulic fluid, interconnecting the working and compensation chambers;
wherein the first and second anchor parts are further connected by at least two generally inelastic straps, each strap extending between and engaging resilient clips located respectively on the first and second anchor parts, the arrangement being such that the straps, the clips and optionally the first and second anchor parts form a loop around the working chamber.

10. A hydraulically damped mounting device according to claim 9, wherein the clips on the first and second anchor parts are respectively formed from a continuous piece of material, and the loop is formed of the straps and the clips only.

11. A hydraulically damped mounting device according to claim 9, having at least one resilient pad between each strap and another part of the mounting device.

12. A hydraulically damped mounting device according to claim 9, wherein the straps are slidably mounted on the clips.

13. A hydraulically damped mounting device according to claim 9, wherein the stiffness of the straps/sleeve is at least 1×10⁶ Nm⁻¹.

14. A hydraulically damped mounting device according to claim 9, wherein the first anchor part is a cup containing the compensation chamber, the cup having an open mouth, and the second anchor part is a boss aligned with the mouth of the cup and connected thereto by the first deformable wall.

15. A hydraulically damped mounting device according to claim 9, having a partition dividing the working chamber from the compensation chamber, wherein the passageway connecting the working chamber and the compensation chamber is in the partition.
